(19) United States
(12) Patent Application Publication
(10) Pub. No.: US 2010/0148561 A1
(43) Pub. Date: Jun. 17, 2010

(54) Deployable Center Armrest

(76) Inventor: David M. Runde, Beverly Hills, MI (US)

Correspondence Address: MAGNA INTERNATIONAL, INC., 337 MAGNA DRIVE, AURORA, ON, L4G-7K1, CA

(21) Appl. No.: 12/600,508

(22) PCT Filed: May 15, 2008
(86) PCT No.: PCT/CA08/00944

§ 371 Date: Nov. 17, 2009

Related U.S. Application Data
(60) Provisional application No. 60/938,814, filed on May 18, 2007.

(51) Int. Cl. B60N 2/46; A47C 7/54; F16C 11/04; F16H 21/04

(52) U.S. Cl. 297/411.33; 74/105

(57) ABSTRACT

An armrest assembly for a vehicle seat includes a bracket and an armrest. The bracket includes first and second elongated slots. The armrest includes a first pin pivotally and slidably disposed in the first slot and a second pin pivotally and slidably disposed in the second slot. Pivotal movement of the armrest between a stowed position and a deployed position urges the first pin along the first slot and the second pin along the second slot thereby lifting the armrest to prevent interference between the armrest and the seat.

### BACKGROUND OF THE INVENTION

1. Field of the Invention

The present invention relates to a deployable center armrest for a bench-type seat assembly of an automotive vehicle. More particularly, the present invention relates to a deployable center armrest that utilizes a pivot-lift mechanism for moving the armrest between a stowed position and a deployed position.

2. Description of Related Art

A bench-type seat assembly for an automotive vehicle having a seatback and seat cushion will often include a center armrest for seat occupant comfort. Typically, the armrest is deployable from a stowed or non-use position to a deployed or use position by rotating the armrest about a fixed pivot in the seatback at a base or proximal end of the armrest. The stowed position is a generally vertical position with the armrest fitted into the seatback to form a flush seatback surface and the deployed position is a generally horizontal position at approximately elbow height for the seat occupant. In operation, the armrest will be rotated by the occupant between the stowed position and the deployed position.

One disadvantage of the fixed pivot design is that a large radius is required at the base end of the armrest to allow for rotation of the armrest without the base end interfering with the seatback. This large radius, however, results in a gap between the base end of the armrest and the seatback when the armrest is in the stowed position. This gap is undesirable in modern vehicles.

To minimize the gap, it is common to provide a four-bar linkage for connecting the armrest to the seatback. The four-bar linkage allows the armrest to follow a path of movement between the stowed and deployed positions such that the base end does not interfere with the seatback.

Several disadvantages of using the four-bar linkage design include that it is complicated, costly, requires multiple parts, and is susceptible to buzz, squeak, and rattle issues. Consequently, it is desirable to provide a simplified mechanism for moving an armrest coupled to a seatback between a stowed position and a deployed position such that a base end of the armrest does not interfere with the seatback. It is also desirable to provide the armrest having a radius at the base end sufficiently small such that when the armrest is in the stowed position only a small gap is created between the base end and the seatback.

### SUMMARY OF THE INVENTION

According to one aspect of the invention, a seat assembly for an automotive vehicle includes a seatback having a recess formed therein. A bracket is fixedly secured to the seatback and includes a first elongated slot and a second elongated slot. An armrest includes a first pin that is pivotally and slidably disposed in the first slot and a second pin that is pivotally and slidably disposed in the second slot. Pivotal movement of the armrest between a generally vertical stowed position disposed within the recess and a generally horizontal deployed position extending from the recess urges the first pin along the first slot and the second pin along the second slot thereby lifting the armrest to prevent interference between the armrest and the seatback.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view a seat assembly for an automotive vehicle including a deployable center armrest according to the prior art in a stowed position;

FIG. 1A is a cross-sectional view taken through lines 1A-1A of FIG. 1;

FIG. 2 is a perspective view of the seat assembly including the deployable center armrest of FIG. 1 in a deployed position;

FIG. 3 is a perspective view of a seat assembly for an automotive vehicle including a deployable center armrest according to the invention in a stowed position;

FIG. 3A is a cross-sectional view taken through lines 3A-3A of FIG. 3;

FIG. 4 is a perspective view of the seat assembly including the deployable center armrest of FIG. 3 in a deployed position;

FIG. 5 is a cross-sectional side view of the seat assembly including the deployable center armrest of FIG. 3 in the stowed position;

FIG. 6 is a cross-sectional side view of the seat assembly including the deployable center armrest of FIG. 3 in a position midway between the stowed and deployed positions;

FIG. 7 is a cross-sectional side view of the seat assembly including the deployable center armrest of FIG. 3 in the deployed position;

FIG. 8 is a cross-sectional side view of the seat assembly including a deployable center armrest according to an alternative embodiment of the invention in a stowed position;

FIG. 9 is a cross-sectional side view of the seat assembly including the deployable center armrest of FIG. 8 in a position midway between the stowed position and a deployed position; and

FIG. 10 is a cross-sectional side view of the seat assembly including the deployable center armrest of FIG. 8 in the deployed position.

### DETAILED DESCRIPTION OF THE EMBODIMENTS

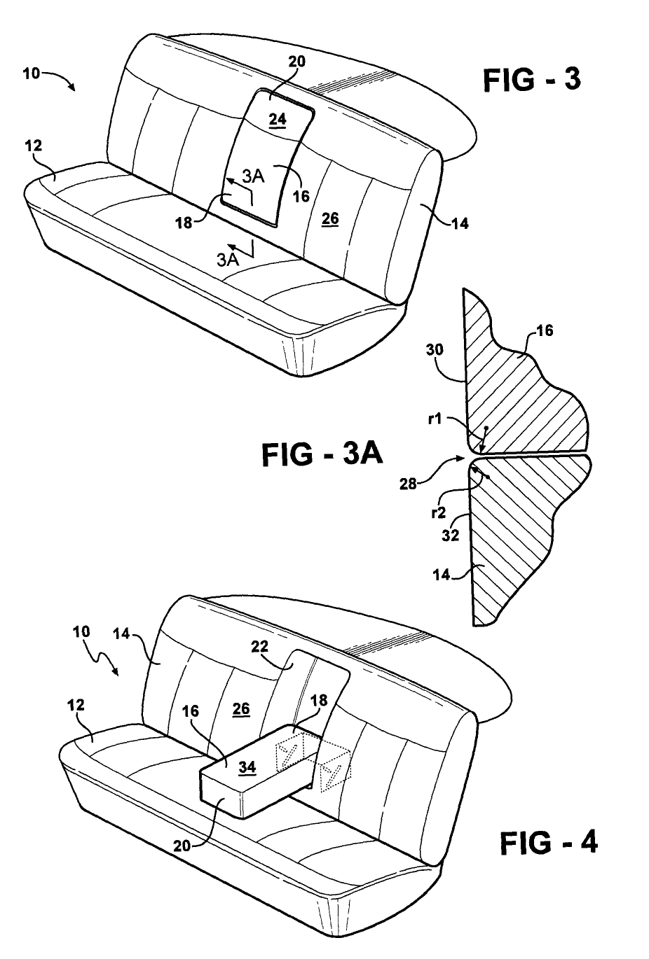

Referring to FIGS. 3 and 4, a conventional bench-type seat assembly, generally shown at 10, includes a seat cushion 12 and a seatback 14. The seat assembly 10 also includes an armrest 16 extending between a proximal end 18 operatively connected to the seatback 14 and an opposite distal end 20. The seatback 14 includes a pocket or recess 22 for stowing the armrest 16 therein.

In FIG. 3, the armrest 16 is shown in a generally vertical non-use or stowed position disposed within the recess 22 of the seatback 14. In the stowed position, an underside 24 of the armrest 16 is flush with a seating surface 26 of the seatback 14. There is a small gap or closeout 28 between the seat trim outline at a front lower corner 30 of the armrest 16 and the seat trim outline at a front upper corner 32 of the seatback 14, best seen in FIG. 3A. The small gap 28 is created by the front lower corner 30 of the armrest 16 having a small radius r1 and the front upper corner 32 of the seatback 14 having a correspondingly small radius r2.

In FIG. 4, the armrest 16 is shown in a generally horizontal use or deployed position with the distal end 20 extending from the seatback 14 and the proximal end 18 coupled to the seatback 14. In the deployed position, a top side or use surface 34 of the armrest 16 is facing upward to provide support for an occupant's arm.

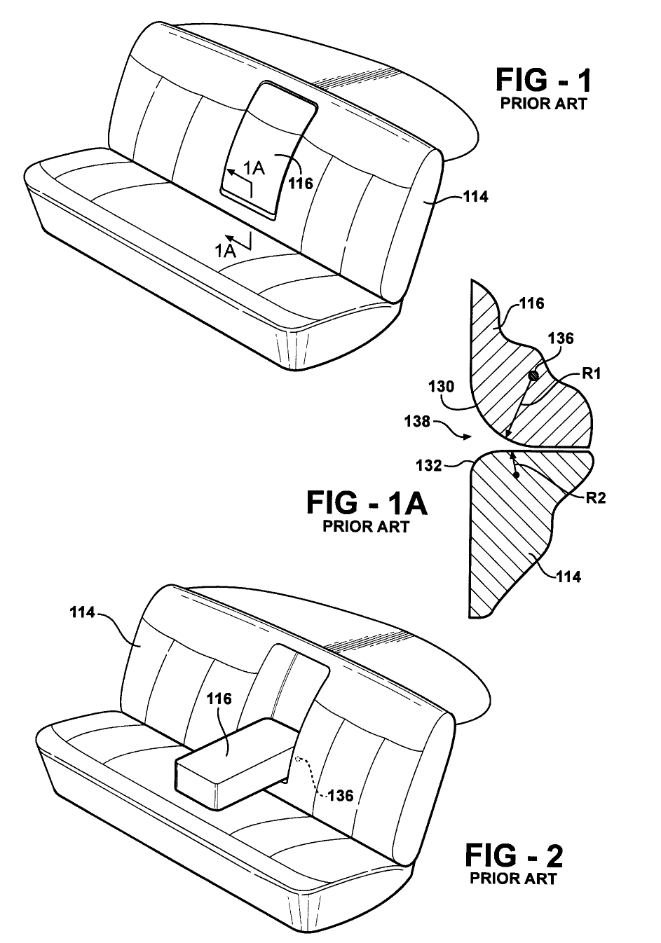

Referring to FIGS. 1 through 2, in the prior art, an armrest 116 is coupled to a seatback 114 using a fixed pivot 136. A large gap or closeout 138 between the seat trim outline at a front lower corner 130 of the armrest 116 and the seat trim outline at a front upper corner 132 of the seatback 114, best seen in FIG. 1A, is necessary to provide clearance to allow the armrest 116 to pivot about the fixed pivot 136 between the stowed and deployed positions. The large gap 138 is created by the front lower corner 130 of the armrest 116 having a large radius R1 and the front upper corner 132 of the seatback 114 having a correspondingly large radius R2. This large gap 138, however, creates an undesirable appearance when the armrest 116 is in the stowed position.

Although the small gap 28 improves the appearance when the armrest 16 is in the stowed position, if the armrest 16 is coupled to the seatback 14 by the fixed pivot 136 of the prior art, the front lower corner 30 of the armrest 16 will bind against or interfere with the front upper corner 32 of the seatback 14 as the armrest 16 pivots between the stowed and deployed positions. Therefore, the present invention provides a movement of the armrest 16 to avoid such interference as the armrest 16 pivots between the stowed and deployed positions without the necessity of the large gap 138.

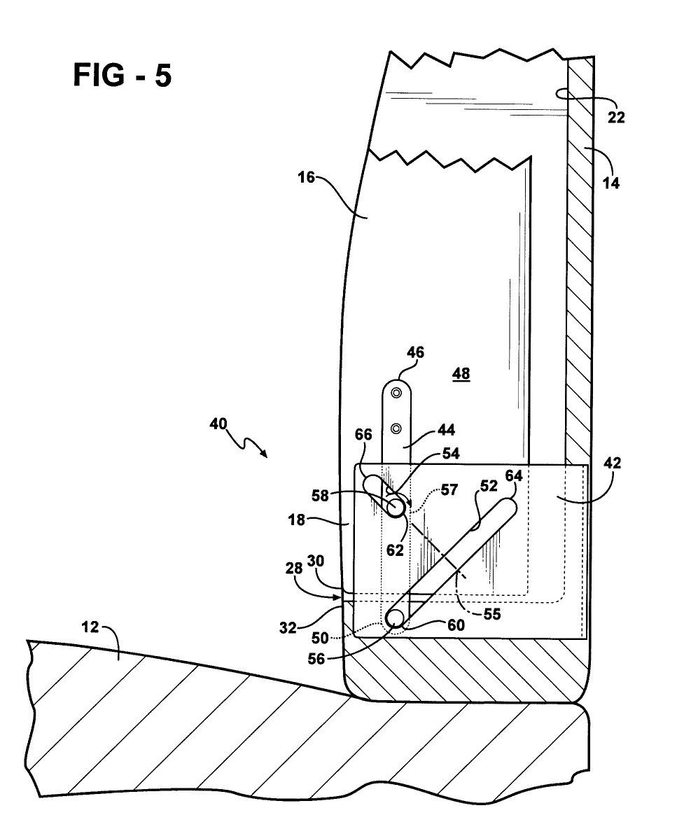

Referring to FIGS. 5 through 7, a pivot-lift mechanism, generally shown at 40, operatively couples the armrest 16 and the seatback 14. The pivot-lift mechanism 40 includes a bracket 42 having a generally U-shaped profile and that extends around the armrest 16. The bracket 42 is fixedly secured to the seatback 14. A pair of support bars 44 (one shown) is pivotally and slidably coupled to the bracket 42. Each side of the pivot-lift mechanism 40 is the same and includes one of the pair of support bars 44 pivotally and slidably coupled to one side of the bracket 42. Each support bar 44 extends between a first end 46 fixedly secured to a side 48 of the armrest 16 at the proximal end 18 thereof and an opposite second end 50.

Each side of the bracket 42 includes a first elongated slot 52 disposed approximately at a forty-five degree (45°) angle and a shorter second elongated slot 54 spaced apart from and disposed perpendicular to the first slot 52. The second slot 54 is aligned with a midpoint 55 of the first slot 52. The second end 50 of the support bar 44 is pivotally and slidably coupled to the first slot 52 by a first pin 56 protruding laterally therefrom. An intermediate point 57 along the support bar 44 between the first and second ends 46, 50 is pivotally and slidably coupled to the second slot 54 by a second pin 58 protruding laterally therefrom.

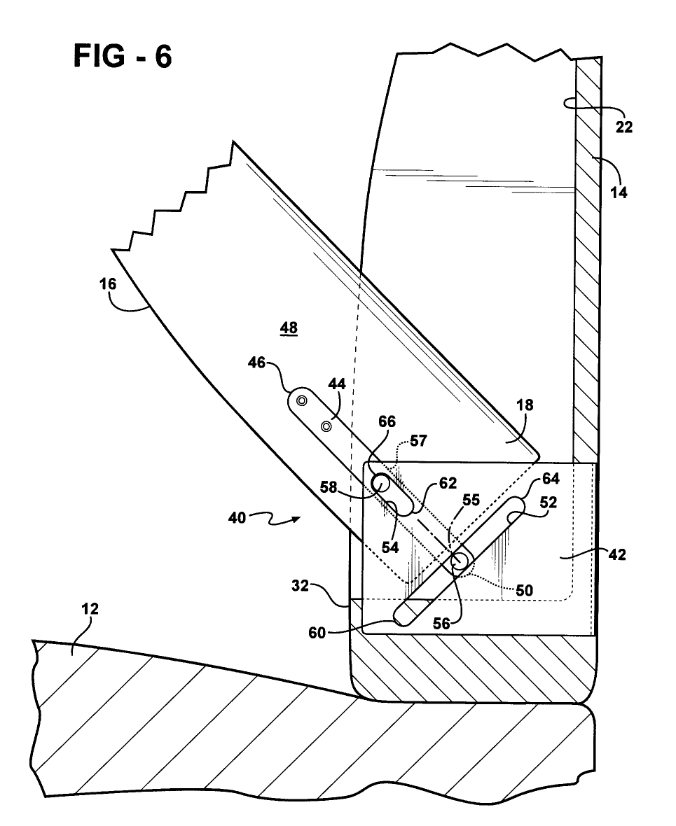

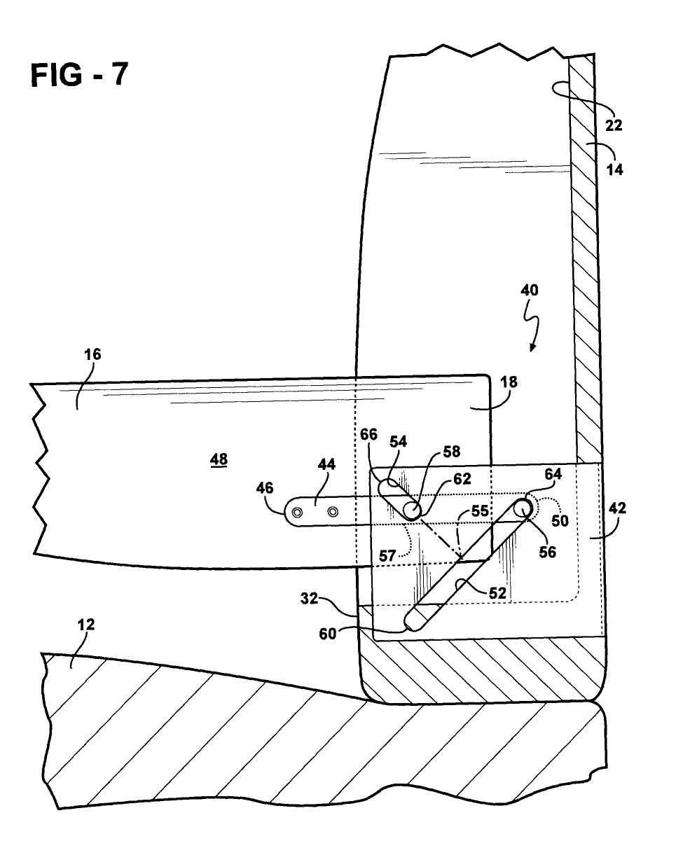

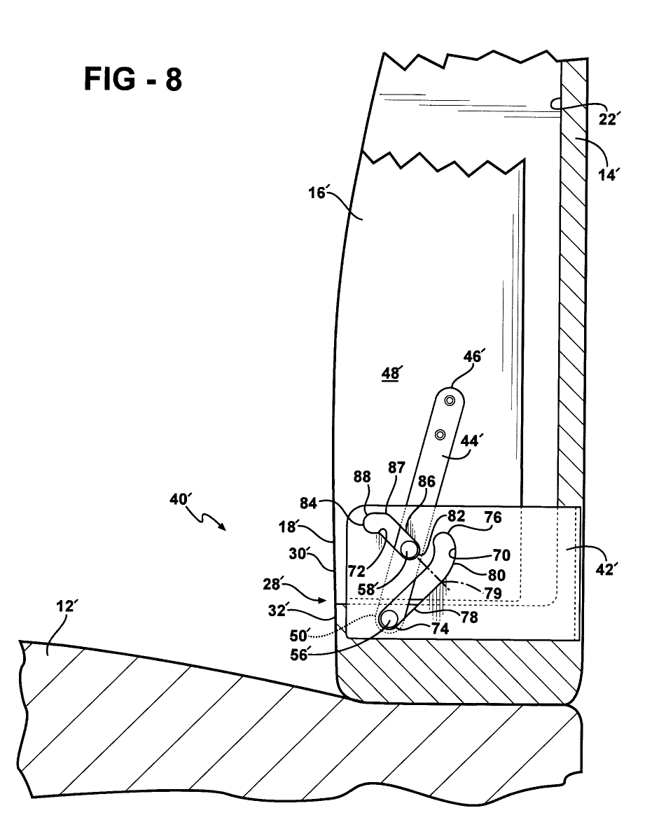

In operation, when the armrest 16 is in the generally vertical stowed position, the pair of support bars 44 is also in a generally vertical position. The first pin 56 is disposed at a first end 60 of the first slot 52 and the second pin 58 is disposed at a first end 62 of the second slot 54. As the armrest 16 pivots from the stowed position to the deployed position, the first pin 56 moves along the first slot 52 toward a second end 64 and urges the second pin 58 along the second slot 54 toward a second end 66, thereby lifting the proximal end 18 of the armrest 16 to prevent contact between the front lower corner 30 of the armrest 16 and the front upper corner 32 of the seatback 14. At the same time, the front lower corner 30 of the armrest 16 moves along a linear path into the recess 22. When the second pin 58 reaches the second end 66 of the second slot 54, the first pin 56 is disposed at the midpoint 55 of the first slot 52, and the armrest 16 is midway between the stowed and deployed positions, as shown in FIG. 6. The first pin 56 continues along the first slot 52 toward the second end 64, which urges the second pin 58 along the second slot 54 back toward the first end 62. At the same time, the front lower corner 30 continues to move along the linear path into the recess 22. The armrest 16 is in the generally horizontal deployed position when the first pin 56 is disposed at the second end 64 of the first slot 52 and the second pin 58 is disposed at the first end 62 of the second slot 54. The pair of support bars 44 is in a generally horizontal position when the armrest 16 is in the deployed position, as shown in FIG. 7.

It is contemplated that the first slot 52 could include a detent (not shown) at each of the first and second ends 60, 64 for positively engaging the first pin 56 when the armrest 16 is in the stowed and deployed positions, respectively. It is also contemplated that the first slot 52 could include a plurality of detents (not shown) disposed therealong for positively engaging the first pin 56 to define any number of intermediate positions of the armrest 16 between the stowed and deployed positions.

It is further contemplated that any number of changes could be made to the bracket 42 depending on the desired positioning of the stowed and deployed positions of the armrest 16 and the desired movement of the armrest 16 as it moves between the stowed and deployed positions. For example, the shape, length, position, and orientation of the first and second slots 52, 54 could be changed without varying the scope of the invention. It is also contemplated that the pivot-lift mechanism 40 can be practiced in other applications wherein the armrest 16 is replaced with a member that is pivotally moveable between a first position and a second position. For example, the pivot-lift mechanism 40 can be practiced in applications where the member is a deck lid or trunk lid, a vehicle door, a head restraint, or a furniture component.

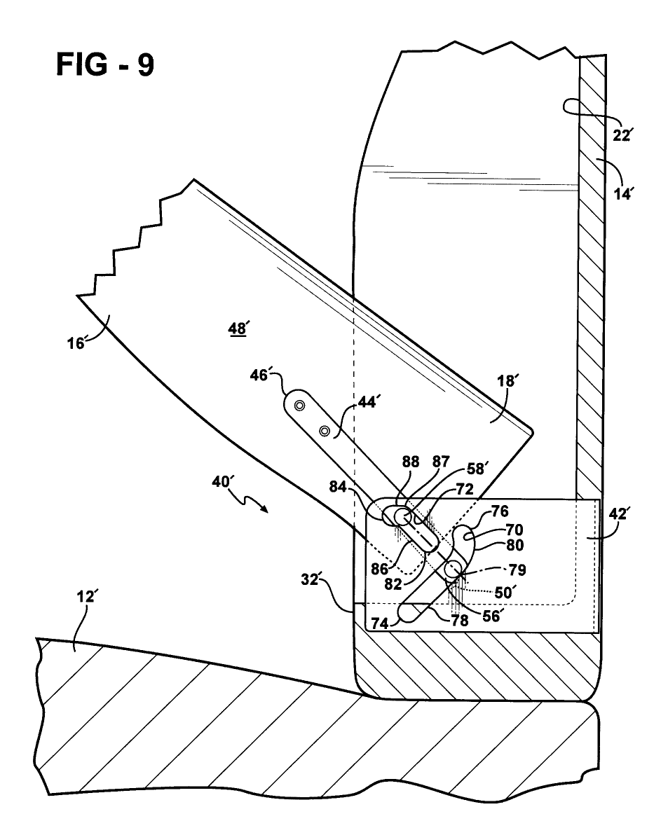

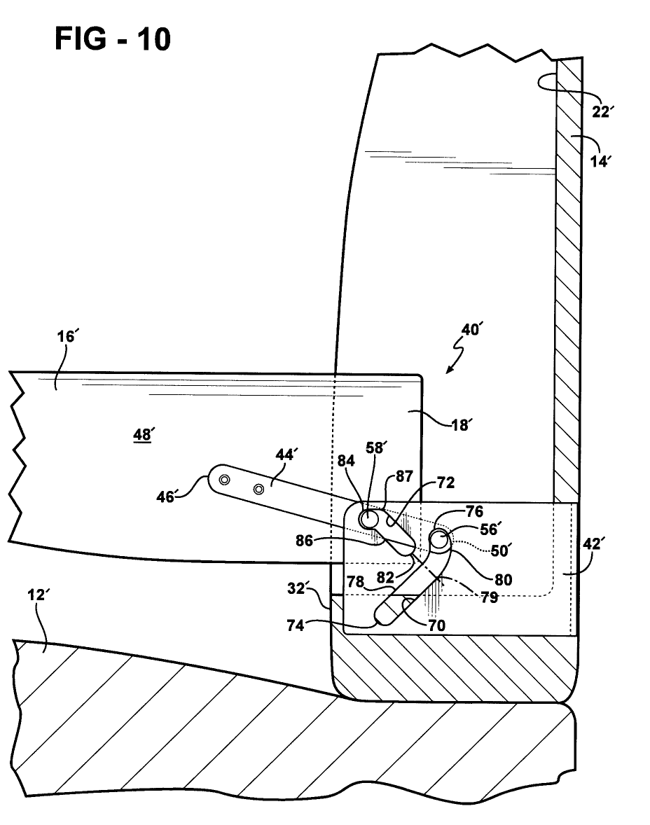

Referring to FIGS. 8 through 10, wherein like primed reference numerals represent similar elements as those described above, in a second embodiment of the invention each side of the bracket 42′ includes a first elongated slot 70 disposed approximately at a forty-five degree (45°) angle and a shorter second elongated slot 72 spaced apart from the first slot 70. The first slot 70 extends between a first end 74 and a second end 76. The first slot 70 includes a linear portion 78 extending from the first end 74 to an intermediate point 79. A curved or arcuate portion 80 extends from the intermediate point 79 to the second end 76. The second slot 72 extends between a first end 82 and a second end 84. The second slot 72 includes a first linear portion 86 extending from the first end 82 to an intermediate point 87. The first linear portion 86 is disposed perpendicular to the linear portion 78 of the first slot 70 and is aligned with the intermediate point 79 thereof. A second linear portion 88 extends from the intermediate point 87 of the second slot 72 to the second end 84 thereof and is disposed generally horizontal.

In operation, when the armrest 16′ is in the stowed position, the first pin 56′ is disposed at the first end 74 of the first slot 70 and the second pin 58′ is disposed at the first end 82 of the second slot 72. As the armrest 16′ pivots from the stowed position to the deployed position, the first pin 56′ moves along the linear portion 78 of the first slot 70 and urges the second pin 58′ along the first linear portion 86 of the second slot 72, thereby lifting the proximal end 18′ of the armrest 16′ to prevent contact between the front lower corner 30′ of the armrest 16′ and the front upper corner 32′ of the seatback 14′. When the second pin 58′ reaches the intermediate point 87 of the second slot 72, the first pin 56′ is disposed at the intermediate point 79 of the first slot 70. The first pin 56′ continues along the arcuate portion 80 of the first slot 70, thereby continuing to lift the proximal end 18′ of the armrest 16′, which urges the second pin 58′ along the second linear portion 88 of the second slot 72, thereby moving the armrest 16′ forward. The armrest 16′ is in the deployed position when the first pin 56′ is disposed at the second end 76 of the first slot 70 and the second pin 58′ is disposed at the second end 84 of the second slot 72.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. An armrest assembly comprising:
a bracket including first and second elongated slots; and
an armrest including first and second pins, said first pin pivotally and slidably disposed in said first slot and said second pin pivotally and slidably disposed in said second slot, whereby pivotal movement of said armrest between a stowed position and a deployed position urges said first pin along said first slot and said second pin along said second slot.

2. An armrest assembly as set forth in claim 1 wherein said first and second slots each extend between a first end and a second end.

3. An armrest assembly as set forth in claim 2 wherein said first pin is disposed at said first end of said first slot and said second pin is disposed at said first end of said second slot when said armrest is in said stowed position, and wherein said first pin is disposed at said second end of said first slot and said second pin is disposed at said first end of said second slot when said armrest is in said deployed position.

4. An armrest assembly as set forth in claim 3 wherein said first and second slots are linear between each of said first and second ends, and said second slot is disposed generally perpendicular to said first slot.

5. An armrest assembly as set forth in claim 4 wherein said second slot is shorter than said first slot and is aligned generally midway between said first and second ends of said first slot.

6. An armrest assembly as set forth in claim 5 wherein said first pin is disposed generally midway between said first and second ends of said first slot and said second pin is disposed at said second end of said second slot when said armrest is positioned midway between said stowed and deployed positions.

7. An armrest assembly as set forth in claim 6 wherein said first slot is oriented approximately forty-five degrees from vertical.

8. An armrest assembly as set forth in claim 7 wherein pivoting said armrest between said stowed position and said deployed position provides concurrent linear and vertical movement of said armrest.

9. An armrest assembly as set forth in claim 2 wherein said first slot includes a linear portion at said first end of said first slot and an arcuate portion at said second end of said first slot, and wherein said second slot includes a first linear portion at said first end of said second slot and a second linear portion at said second end of said second slot disposed at an angle relative to said first linear portion.

10. An armrest assembly as set forth in claim 9 wherein said first linear portion of said second slot is disposed generally perpendicular to said linear portion of said first slot.

11. An armrest assembly as set forth in claim 10 wherein said linear portion of said first slot is oriented approximately forty-five degrees from vertical and said second linear portion of said second slot is oriented generally horizontal.

12. An armrest assembly as set forth in claim 11 wherein said first pin is disposed at said first end of said first slot and said second pin is disposed at said first end of said second slot when said armrest is in said stowed position, and wherein said first pin is disposed at said second end of said first slot and said second pin is disposed at said second end of said second slot when said armrest is in said deployed position.

13. A seat assembly for an automotive vehicle comprising:
a seatback including a recess formed therein;
a bracket fixedly secured to said seatback and including first and second elongated slots; and
an armrest including first and second pins, said first pin pivotally and slidably disposed in said first slot and said second pin pivotally and slidably disposed in said second slot, whereby pivotal movement of said armrest between a generally vertical stowed position disposed within said recess and a generally horizontal deployed position extending from said recess urges said first pin along said first slot and said second pin along said second slot thereby lifting said armrest to prevent interference between said armrest and said seatback.

14. A pivot-lift mechanism comprising:
a member that is movable between a first position and a second position; and
a bracket having first and second elongated slots, said first slot generally disposed across said bracket, said second slot generally disposed across said bracket and aligned perpendicular to said first slot;
wherein said member is pivotally and slidably coupled to said first and second slots for concurrent linear and vertical movement of said member when pivoted between said first and second positions.

15. A pivot-lift mechanism as set forth in claim 14 wherein said first slot is generally disposed approximately at a forty-five degree angle from vertical.

16. A pivot-lift mechanism as set forth in claim 14 wherein said first and second slots each extend between a first end and a second end.

17. A pivot-lift mechanism as set forth in claim 16 further including first and second pins pivotally and slidably coupling said member to said first and second slots.

18. A pivot-lift mechanism as set forth in claim 17 wherein said member is an armrest.

19. A pivot-lift mechanism as set forth in claim 18 wherein said first position is a generally vertical position and said second position is a generally horizontal position.

20. A pivot-lift mechanism as set forth in claim 19 wherein said first pin is disposed at said first end of said first slot and said second pin is disposed at said first end of said second slot when said armrest is in said vertical position, and wherein said first pin is disposed at said second end of said first slot and said second pin is disposed at said first end of said second slot when said armrest is in said horizontal position.

21. A pivot-lift mechanism as set forth in claim 20 wherein said first and second slots are each linear between said first and second ends.

22. A pivot-lift mechanism as set forth in claim 21 wherein said second slot is shorter than said first slot and is aligned generally midway between said first and second ends of said first slot.

23. A pivot-lift mechanism as set forth in claim 22 wherein said first pin is disposed generally midway between said first and second ends of said first slot and said second pin is disposed at said second end of said second slot when said armrest is positioned midway between said vertical and horizontal positions.

24. A pivot-lift mechanism as set forth in claim 17 wherein said first slot includes a linear portion at said first end of said first slot and an arcuate portion at said second end, and wherein said second slot includes a first linear portion at said first end of said second slot and a second linear portion at said second end of said second slot disposed at an angle relative to said first linear portion.

25. A pivot-lift mechanism as set forth in claim 24 wherein said first linear portion of said second slot is disposed generally perpendicular to said linear portion of said first slot.

26. A pivot-lift mechanism as set forth in claim 25 wherein said linear portion of said first slot is oriented approximately forty-five degrees from vertical and said second linear portion of said second slot is oriented generally horizontal.

27. A pivot-lift mechanism as set forth in claim 26 wherein said member is an armrest, said first position is a generally vertical position, and said second position is a generally horizontal position, wherein said first pin is disposed at said first end of said first slot and said second pin is disposed at said first end of said second slot when said armrest is in said vertical position, and wherein said first pin is disposed at said second end of said first slot and said second pin is disposed at said second end of said second slot when said armrest is in said horizontal position.
